(19) United States
(12) Patent Application Publication
(10) Pub. No.: US 2010/0169371 A1
(43) Pub. Date: Jul. 1, 2010

(54) Types of nodes in a kstore

(76) Inventor: Jane C. Mazzagatti, Blue Bell, PA (US)

Correspondence Address: UNISYS CORPORATION, UNISYS WAY, MAIL STATION: E8-114, BLUE BELL, PA, 19424, US

(21) Appl. No.: 12/319,029

(22) Filed: Dec. 31, 2008

(51) Int. Cl. G06F 17/30; G06F 7/00

(52) U.S. Cl. 707/774; 707/E17.044

(57) ABSTRACT

The KStore or K is a datastore made up of a forest of interconnected, highly unconventional trees of one or more levels. Nodes in a KStore are typically comprised of at least four fields, including a pointer to an asCase node, a pointer to an asResult node, a pointer to an asCaseList and a pointer to an asResultList. Because either an asCaseList or an asResultList but not both will exist in any particular node, two new node types are created, one node comprising a node with an asCase pointer, an asResult pointer and asCaseList pointer but not including a pointer to an asResultList and one node with a pointer to an asCase node, and asResult node and an asResultList but not including a pointer to an asCaseList. Alternatively, a single node structure may exist with a pointer to a list in one field and an indicator stored in another field that indicates directly or indirectly whether the list pointed to is an asCaseList or an asResultList.

### RELATED APPLICATIONS

This application claims the benefit of U.S. patent application Ser. No. 11/084,996, filed Mar. 18, 2005, entitled “SYSTEM AND METHOD FOR STORING AND ACCESSING DATA IN AN INTERLOCKING TREES DATASTORE” by MAZZAGATTI et al. which application is a Continuation of U.S. patent application Ser. No. 10/385,421, filed Mar. 10, 2003 and U.S. patent application Ser. No. 11/185,620, filed Jul. 20, 2005, entitled “METHOD FOR PROCESSING NEW SEQUENCES BEING RECORDED INTO AN INTERLOCKING TREES DATASTORE,” by MAZZAGATTI. These applications are incorporated in their entirety herein.

### TECHNICAL FIELD

The present disclosure relates to data processing systems, and datastores to such systems. In particular, the present disclosure relates to data node types related to an interlocking trees datastore.

### BACKGROUND

Data structures facilitate the organization and referencing of data. Many different types of data structures are known in the art, including linked lists, stacks, trees, arrays and others. The tree is a widely-used hierarchical data structure of linked nodes. The conventional tree is an acyclic connected graph where each node has a set of zero or more child nodes and at most one parent node. A tree data structure, unlike its natural namesake, grows down instead of up, so that by convention, a child node is typically referred to as existing “below” its parent. A node that has a child is called the child's parent node (or ancestor node, or superior node). In a conventional tree, a node has at most one parent. The topmost node in a tree is called the root node. A conventional tree has at most one topmost root node. Being the topmost node, the root node does not have a parent. Operations performed on the tree commonly begin at the root node. All other nodes in the tree can be reached from the root node by following links between the nodes. Nodes at the bottommost level of the tree are called leaf nodes or terminal nodes. As a leaf node is at the bottommost level, a leaf node does not have any children.

### SUMMARY

The KStore or K is a datastore made up of a forest of interconnected, highly unconventional trees of one or more levels. Each node in the KStore can have many parent nodes. The KStore is capable of handling very large amounts of highly accessible data without indexing or creation of tables. Aspects of KStore are the subject of a number of patents including U.S. Pat. Nos. 6,961,733, 7,158,975, 7,213,041, 7,340,471, 7,348,980, 7,389,301, 7,409,389, 7,418,455 and 7,424,480, which are hereby incorporated by reference in their entirety.

Nodes in a KStore are typically comprised of at least four fields, including a pointer to an asCase node, a pointer to an asResult node, a pointer to an asCaseList and a pointer to an asResultList. Because either an asCaseList or an asResultList but not both will exist in any particular node, two new node types can be created, one node type comprising a node with an asCase pointer, an asResult pointer and a pointer to an asCaseList and one node type comprising a node with an asCase pointer, an asResult pointer and a pointer to an asResultList. The asCaseList and asResultList fields are pointers to pointer lists and thus are the same size or larger than the asCase or asResult fields, thus the eliminated field can reduce the size of the node by about 25%. As a KStore is composed essentially entirely of nodes, eliminating the pointer to pointer list filed can reduces the size of the KStore itself by about 25%. As KStores on the order of 50 GigaBytes are not uncommon, large amounts of space can be saved by elimination of the pointer to a pointer list field. Alternatively, a single node structure may exist with a pointer to a list in one field and an indicator stored in another field that indicates whether the list pointed to is an asCaseList or an asResultList.

### BRIEF DESCRIPTION OF THE DRAWINGS

In the drawings:

FIG. 1 is a block diagram illustrating an example of an interlocking trees datastore (KStore or K) in accordance with aspects of the subject matter disclosed herein;

FIG. 2 is an example of a dataset from which the KStore of FIG. 1 was generated in accordance with aspects of the subject matter disclosed herein;

FIG. 3 is a block diagram illustrating an example of a node structure of a node of an interlocking trees datastore (KStore or K) in accordance with aspects of the subject matter disclosed herein;

FIG. 4 is a block diagram illustrating another example of a node structure of a node of an interlocking trees datastore (KStore or K) in accordance with aspects of the subject matter disclosed herein;

FIG. 5 is a block diagram illustrating an example of a node structure of a node of an interlocking trees datastore (KStore or K) in accordance with aspects of the subject matter disclosed herein;

FIG. 6 is a flow diagram of a method for accessing different types of nodes in a KStore in accordance with aspects of the subject matter disclosed herein;

FIG. 7 illustrates a generalized node data structure of a KStore data structure in accordance with embodiments of the invention;

FIG. 8 illustrates an example of a system environment in which aspects of the subject matter disclosed herein can be practiced; and

FIG. 9 illustrates an example of levels in a KStore in accordance with aspects of the subject matter disclosed herein.

### DETAILED DESCRIPTION

### Overview of KStore Data Structure

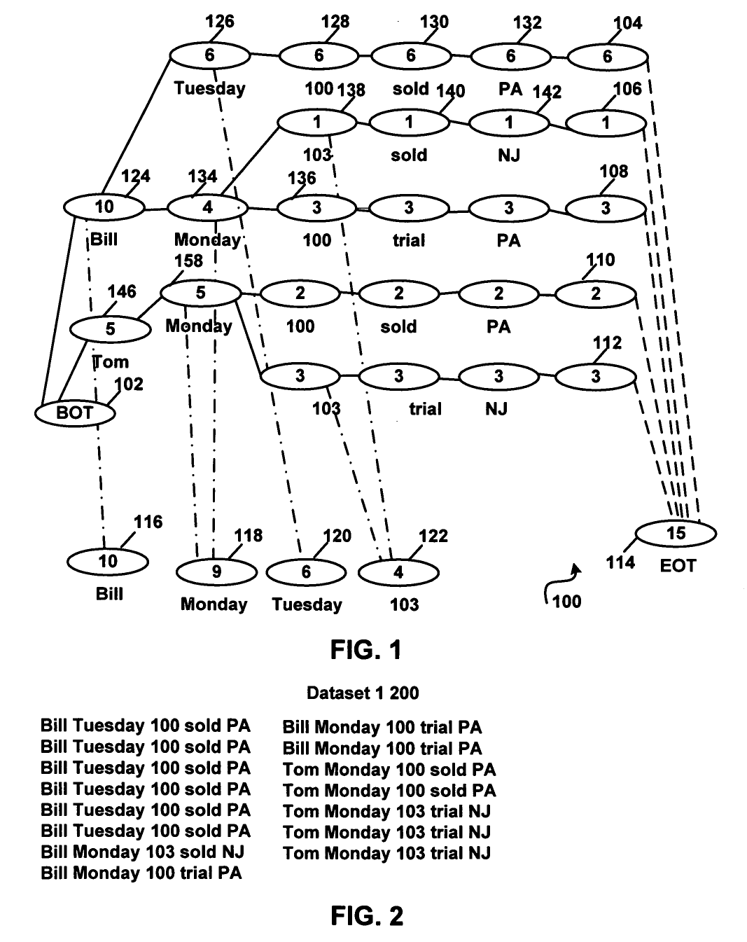

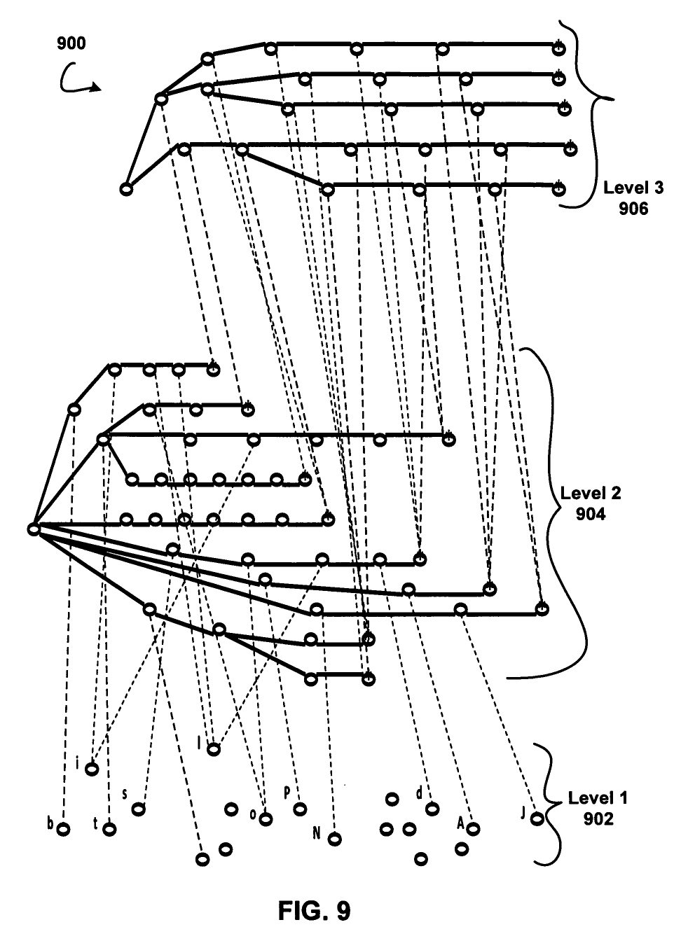

A KStore or K is a datastore made up of a forest of interconnected trees. FIG. 9 illustrates a multi-level KStore structure 900 created from the data in Dataset 1 200 of FIG. 2. The highest level (level 3) 906 of the KStore 900 represents the KStore 100 illustrated in FIG. 1 and represents records (e.g., Tom-Monday-103-trial-NJ). The middle level (level 2) 904 represents the field content or variables (the root nodes of KStore 100) which make up the records of level 3 906 (e.g., the variable Tom, the variable Tuesday, etc.) and the lowest level (level 1) 902 represents the universe of dataset elements that are combined to make up the variables (e.g., the letter T, the letter o, the number 1, the number 0 and so on). It will be appreciated that multi-level KStores of any number of levels can exist. Additional levels can be added or removed at any time, and existing levels can be updated at any time. For example, an additional level (level 4, not shown) representing datasets (of which Dataset 1 200 of FIG. 2 is one dataset) can be added above level 3 906. Additional records can be added to level 3 906. Additional variables can be added to level 2 904. Additional dataset elements (e.g., the letter v) can be added to level 1 902. Moreover, updates to one level of the KStore are propagated to other levels as required. For example, the addition of a record for Violet-Tuesday-100-sold-NY, would be reflected in all the levels of the KStore. The record would be added to level 3 906, the variables of level 2 904 would be updated to include the new variables Violet and NY and the list of elemental root nodes of the lowest level, level 902 of FIG. 9 would be updated to include elemental root nodes for V and Y.

The interlocking trees datastore comprises a first tree that depends from a first root node (a primary root node) and may include a plurality of branches. Each of the branches of the first tree ends in a leaf node called an end product node. The first root node may represent a concept, such as but not limited to a level begin indicator (e.g., BOT or Beginning of Thought). For example, referring to FIG. 1, KStore 100 includes a first tree depending from a first root node 102 and including 5 branches (e.g. the topmost branch is comprised of nodes 102, 124, 128, 130, 132 ending with the leaf node 104.

A second root (e.g., root node 114) of the same level of the same trees-based datastore is linked to each leaf node of the first tree (e.g., to nodes 104, 106, 108, 110 and 112) and is called an EOT (End Of Thought) node. Leaf nodes of a KStore are also called end product nodes. End product nodes include a count that reflects the number of times the sequence of nodes from BOT to EOT has occurred for the unique sequence of nodes that end with that particular end product node. For example, node 106 with a count of 1 reflects the counts associated with the path connecting nodes 102, 124, 134, 138, 140 and 142. The second root (e.g., root node 114) is a root to an inverted order of the first tree or to an inverted order of some subset of the first tree, but does not duplicate the first tree. Node 134 is a node that is shared by the KStore path that ends with end product node 106 and by the KStore path that ends with end product node 108. Thus the count of node 134 (4) is the combination of the count of node 106 (1) and the count of node 108 (3).

Finally, the trees-based datastore comprises a plurality of trees of a third type in which the root node of each of these trees can be described as an end product node of an immediately adjacent lower level or as an elemental root node and may include or point to data such as a dataset element or a representation of a dataset element. The root nodes 116, 118, 120 and 122 are end product nodes of the immediately adjacent lower level of the KStore. It will be appreciated that not all of the root nodes of KStore 100 are illustrated in FIG. 1 to avoid unduly cluttering the Figure. The root node of each of these trees may be linked to one or more nodes in one or more branches of the unduplicated first tree. The nodes of the trees-based datastore may contain pointers to other nodes in the trees-based datastore instead of data per se, and may also contain additional fields. One such additional field may be a count field (e.g., the count field of node 120 is 6 and the count field of node 108 is 3). Multiple levels of the above-described tree-based datastore may be generated and accessed, the end products of the lower level becoming the root nodes of the next level.

FIG. 1 represents KStore 100, a portion of a KStore generated from Dataset 1 200 illustrated in FIG. 2. For example, Dataset 1 200 includes a set of six instances of the record Bill Tuesday 100 sold PA. Hence the count for the nodes 126 (Tuesday), 128 (100), 130 (sold), 132 (PA) and node 104 (a count of the number of the Bill Tuesday 100 sold PA records) are all 6. Similarly, there is only one record for Bill Tuesday 100 sold PA thus the counts for nodes 138 (100), 140 (sold), 142 (NJ) and 106 are all 1. The count for node 124 (Bill) is 10 because there are 10 records in Dataset 1 that have Bill in the first field of the record. Similarly the count of node 146 (Tom) is 5 because there are 5 records in Dataset 1 that have Tom in the first field of the record.

Branches of the first tree are called asCase branches or asCase paths. AsCase paths are linked via asCase links denoted by solid lines in the Figures. Together, all the asCase paths of a KStore form the asCase tree of that level. The asCase tree depends from a first root (the primary root, e.g., node 102 in FIG. 1). Multiple asResult branches or asResult paths form multiple asResult trees that depend from respective, multiple roots. AsResult paths are linked via asResult links denoted by dashed lines: (-.-.- and - - - in FIG. 1 and --- in FIG. 9). For example, in FIG. 1 a number of asResult trees are illustrated including the asResult tree comprised of root node 116 representing the dataset element Bill and internal node 124 having a count field of 10 (ten) representing that 10 records of the dataset that resulted in the creation of the KStore of FIG. 1 had a value of Bill in a particular field. Another asResult tree illustrated in FIG. 1 is the asResult tree comprised of the following nodes: root node 118 representing the dataset element Monday, which is linked by asResult links to node 134 and to node 158. The count of root node 118 is 9, the sum of the counts of node 134 (4) and node 158 (5). The count 9 indicates that 9 records of the dataset that resulted in the creation of the KStore of FIG. 1 had a value of Monday in a particular field. One instance of an asResult tree comprises the asResult tree whose root node is node 114. This root node, node 114 in FIG. 1, is linked to each end product node (e.g., nodes 104, 106, 108, 110 and 112). This asResult tree can access the branches of the asCase tree terminating in end products in inverted order. This asResult tree can also be used to define root nodes for the next level. These root nodes may represent dataset elements for the next adjacent level, composed of the set of end products of the lower adjacent level.

The interlocking trees datastore may capture information about relationships between dataset elements encountered in an input file by combining a node that represents a level begin indicator (e.g., BOT) with a node that represents a dataset element to form a node representing a subcomponent. A subcomponent node may be combined with a node representing a dataset element to generate another subcomponent node in an iterative sub-process. Combining a subcomponent node with a node representing a level end indicator may create a level end product node. The process of combining a level begin node with a dataset element node to create a subcomponent and combining a subcomponent with a dataset element node and so on may itself be iterated to generate multiple asCase branches in a level. AsResult trees may also be linked or connected to nodes in the asCase tree, such as, for example, by a root node of an asResult tree pointing to one or more nodes in the asCase tree.

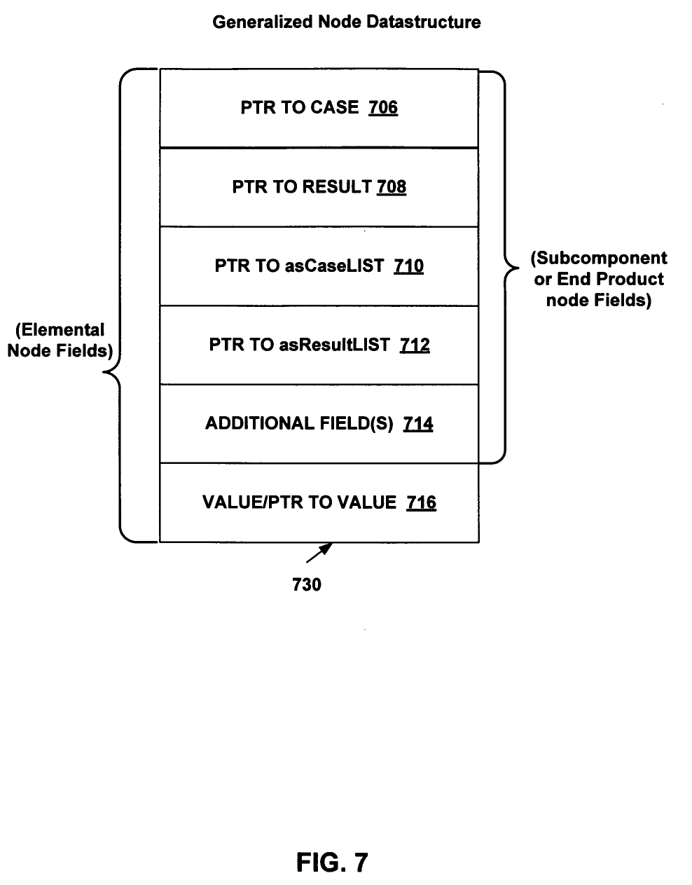

FIG. 7 illustrates the data fields of a typical node, e.g., node 730 of the interlocking trees data structure. Node 730 can represent an elemental root node, subcomponent node or end product node. When a new node is built in an interlocking datastore, memory is allocated for the new node as shown in FIG. 7. A plurality of pointers can then be stored in the allocated memory. The new node is defined by setting the asCase pointer (pointer to Case) 706 to point to the previous node in the path and setting the asResult pointer (pointer to Result) 708 to point to the root node. Thus, for example, if node 730 represents the subcomponent node 124 of the interlocking trees datastore shown in FIG. 1, the asCase pointer 706 would point to the BOT node, node 102 and the asResult pointer 708 would point to the Bill root node, node 116. The pointer to asCaseList 710 is a pointer to a list of the subcomponent nodes or end product nodes for which the node represented by the node 730 is the asCase node. For example, the asCaseList for node 134 would include pointers to nodes 136 and 138. It will be appreciated that the pointer to asCaseList, field 710 will be null for the elemental nodes and for end product nodes. The pointer to asResultList 712 is a pointer to a list of the subcomponents nodes or end product nodes for which the node represented by the exemplary node 730 is the asResult node. For example, the asResultList for node 124 would be empty. It will be appreciated that the pointer to asResultList field 712 will be null for all subcomponent nodes. The asResultList of root node 118 (Monday) includes pointers to nodes 158 and 134 tree. The nodes of the interlocking trees datastore can also include one or more additional fields 714. The additional fields 714 may be used for an intensity or count associated with the node. A count may be incremented or decremented to record the number of times that a node has been accessed or traversed or to record the number of times it was encountered or received in an input dataset. The additional fields 714 may be used for a list of all the elemental root nodes represented by the node or for any number of different items associated with the structure. Another example of a parameter that can be stored in an additional field 716 is the particle value representing a dataset element for an elemental root node. If the node is an elemental root node it may also contain a field 716, comprising the value of the dataset element it represents or a pointer to the value of the dataset element it represents.

As nodes are created, asCase and asResult links may be simultaneously generated at each level and asCaseLists and asResultLists may be generated and updated. As described above, an asCase link represents a link to the first of the two nodes from which a node is created. For example, referring to FIG. 1, the asCase link of node 124 points to node BOT 102. It will be appreciated that asCase branches of the asCase trees may be created by generation of the asCase links as the input is processed. The asCase branches of each level thus provide a direct record of how each subcomponent and end product of the level was created. Hence the asCase branches can be used to represent one possible hierarchical relationship of nodes in the asCase tree. For example if the data received by an interlocking trees generator is data concerning salesmen who sell products identified by product numbers in states of the United States, a particular input dataset may include the two records:

| | | | |
|---|---|---|---|
| Tom | sold | 100 | PA |
| Bill | sold | 40 | NJ |

where Tom and Bill are salesmen, 100 and 40 are product numbers and PA and NJ are states in which the salesmen sold their products. The asCase tree generated from this input may comprise a view of the data in the context of “state information with the context of salesman” context.

An asResult link represents a link to the second of the two nodes from which a node is created. For example, the asResult link of node 124 points to node 116 (Bill). The generation of the asResult links creates a series of interlocking trees where each of the asResult trees depend from a root comprising a dataset element. This has the result of recording all encountered relationships between the root nodes and the nodes of the asCase trees in the KStore. That is, the asResult trees capture all the possible contexts of the nodes of the interlocking trees. If, for example, the input to the interlocking trees datastore generator comprises a universe of sales data including salesman name, day of the week, product number and state, the resulting asResult links of the generated interlocking trees datastore could be used to extract information such as: “What salesmen sell in state X”, “How many items were sold on Monday?” “How many items did Salesman Bill sell on Monday and Tuesday?” and the like, all from the same interlocking trees datastore, without creating multiple copies of the datastore, and without creating indexes or tables.

It will be appreciated that this information is determinable from the structure of the interlocking trees datastore itself rather than from information explicitly stored in the nodes of the structure. Paths can be traversed backwards towards the root node to determine if the subcomponent or end product belongs to a particular category or class of data. Links between nodes may be bidirectional. For example, a root node for the dataset element “Monday” (e.g. root node 118) may include a pointer to a subcomponent BOT-Bill-Monday (e.g., node 134) in node 118's asResultList while the node BOT-Bill-Monday, node 134 may include a pointer to the node Monday, node 118, as its asResult pointer and so on. Furthermore, by following asCase links of the nodes containing a desired dataset element, other subcomponents and end products containing the desired dataset element can be found along the branch of the asCase tree. It will be appreciated that the described features cause the datastore to be self-organizing.

### Types of Nodes in a KStore

As described above, a generalized node in a KStore can be used to instantiate any node in a KStore. However, subcomponent nodes and BOT nodes have entries only in the pointer to asCaseList field because there are no subcomponent nodes which are the asResult node of other nodes. Moreover, elemental root nodes and end product nodes will not have a pointer to an asCaseList in the pointer to asCaseList field because an elemental root node or end product node will not be the Case node for another node. The one exception is the BOT node or primary root node, which will have a pointer to an asCaseList in its asCaseList field. To create a more memory efficient KStore, in accordance with aspects of the subject matter disclosed herein, the unused pointer list pointer is omitted from the nodes of the KStore. Two different node structures can be defined, one having the field for the asCaseList pointer and no field for the asResultList pointer and one having the field for the asResultList pointer and no field for the asCaseList pointer. Alternatively, one node structure can be defined, the node structure comprising a field for a pointer to the asCase node, a field for a pointer to the asResult node, a field for a pointer to a list of pointers and a field for an indicator for the type of the list of pointers the pointer points to or a field for an indicator for the type of node.

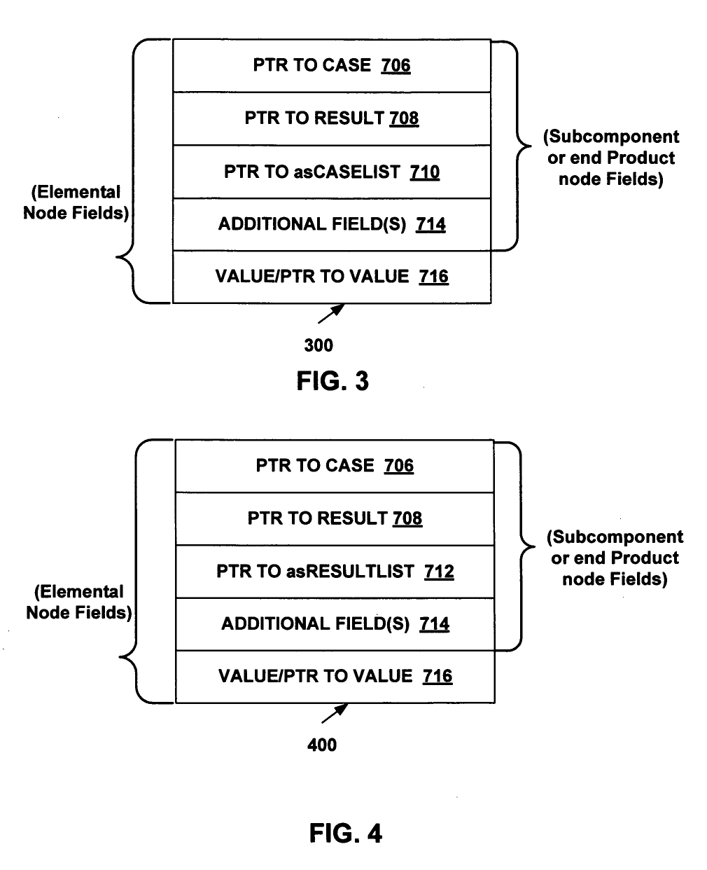

FIG. 3 300 illustrates a first structure of two different node structures of nodes of a KStore. Node 300, which can be a BOT or primary root node or subcomponent node, has a field for a pointer to an asCase node, field 706, a field for a pointer to an asResult node, field 708, a field for a pointer to an asCaseList, field 710. Node 300 may also include one or more additional fields, field 714 and a field for a value or a pointer to a value, field 716 but does not have a field for a pointer to an asResultList.

FIG. 4 400 illustrates a second structure of two different node structures of nodes of a KStore. Node 400, which can be an end product node or an elemental root node except for the BOT node. Node 400 has a field for a pointer to an asCase node, field 706, a field for a pointer to an asResult node, field 708, a field for a pointer to an asResultList, field 712. Node 300 may also include one or more additional fields, field 714 and a field for a value or a pointer to a value, field 716 but does not have a field for a pointer to an asCaseList.

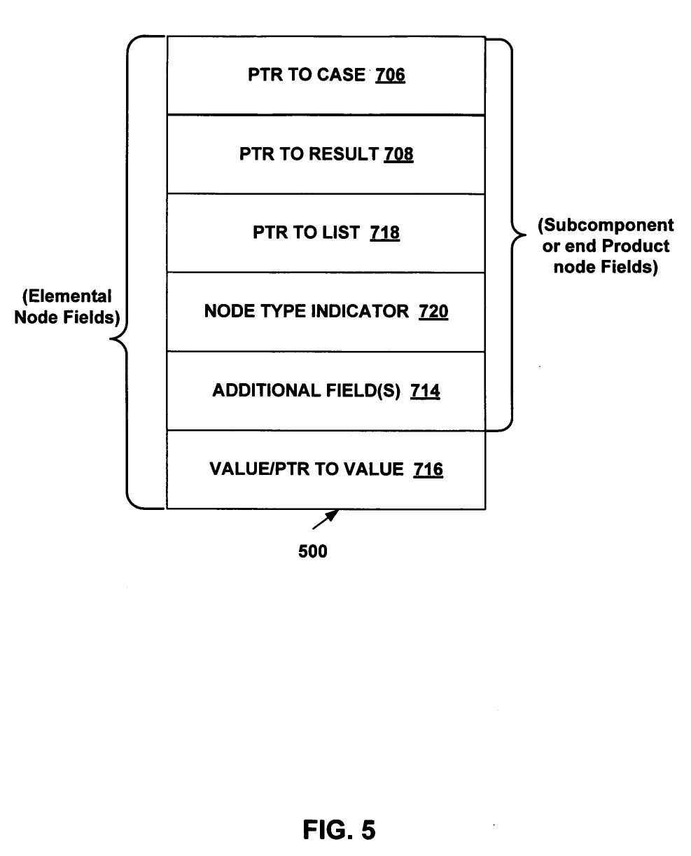

FIG. 5 500 illustrates a node structure of a node of a KStore. Node 500 can represent an end product node, an elemental root node, a BOT node, an EOT node, or a subcomponent node. Node 500 has a field for a pointer to an asCase node, field 706, a field for a pointer to an asResult node, field 708, a field for a pointer to a list, field 718 and a field 720 that includes an indicator for the type of node it is. Node 500 may also include one or more additional fields, field 714 and a field for a value or a pointer to a value, field 716. The field 718 of the node represented by node 500 may have either a pointer to an asCaseList or a pointer to an asResultList but cannot have both pointers to an asCaseList and an asResultList.

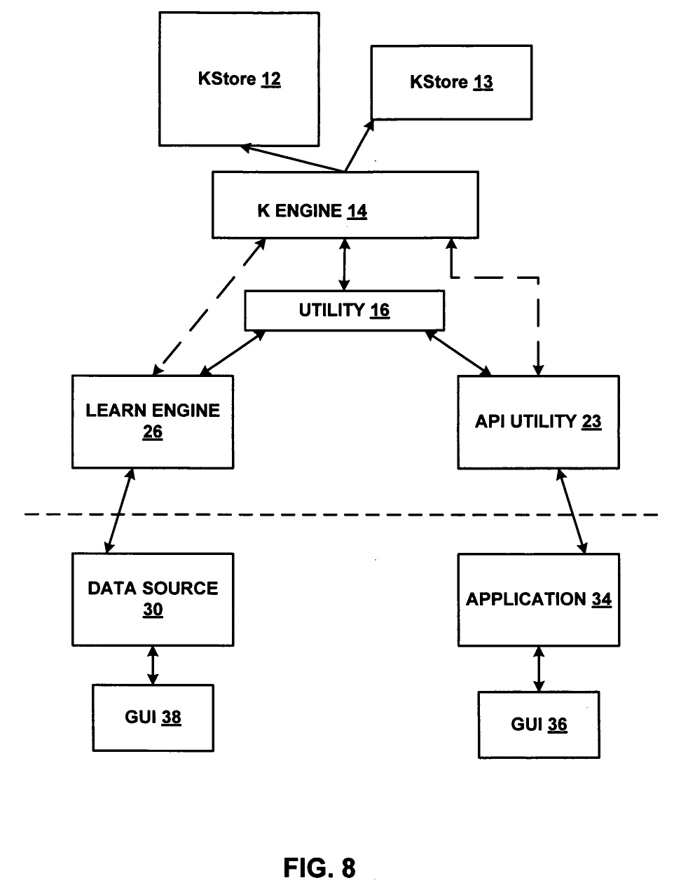

FIG. 8 illustrates an example of a KStore computing environment in which KStores may be implemented. The computing environment may include one or more networked or unnetworked computers capable of implementing and processing KStores on which one or more of the following reside: a K Engine 14, one or more KStores such as KStore 12 and KStore 13, a Learn Engine 26, one or more data sources 30, a utility 16, an application programming interface (API) utility 23, one or more graphical user interfaces (e.g., GUI 38, GUI 36) and one or more applications such as application 34. One or more of: K Engine 14, Learn Engine 26, utility 16, application programming interface (API) 23, graphical user interfaces (e.g., GUI 38, GUI 36) and application 34 may be executed by the processor of a computer.

The Learn Engine 26 may receive data from many types of input data sources and may transform the received data to particles suitable to the task to which the KStore being built will perform. For example, if the data being sent to the KStore is information from a field/record type database, particular field names may be kept, changed, or discarded, depending on the overall design of the KStore the user is creating. After breaking down the input into appropriate particles, the Learn Engine 26 may make appropriate calls to the K Engine 14 and pass the data in particle form in a way that enables the K Engine 14 to put it into the KStore structure,

API utilities such as API utility 23 receive inquiries and transform the received inquiries into calls to the K Engine, to access the KStore directly or to update associated memory. In the event that a query is not to be recorded in the structure of a KStore a LEARN SWITCH may be turned off. In the event that a query is to be recorded in the structure of the KStore, (as in Artificial Intelligence applications, for example) the LEARN SWITCH may be turned on. API utilities may get information from the KStore using predefined pointers that are set up when the KStore is built (rather than by transforming the input into particles and sending the particles to the KEngine). For instance, a field may point to the Record End of Thought (EOT) node, the Field EOT node, the Column EOT node and the Beginning Of Thought (BOT) node. This field may be associated with the K Engine, and may allow the K Engine to traverse the KStore using the pointers in the field without requiring the API Utility to track this pointer information.

Within the KStore computing environment information may flow bi-directionally between the KStore or KStores, a data source 30 and an application 34 by way of a K Engine 14. The transmission of information between the data source 30 and the K Engine 14 may be by way of a learn engine 26, and the transmission of information between the application 34 and the K Engine 14 may be by way of an API or API utility engine 23. Data source 30 and application 34 may be provided with graphical user interfaces 36, 38 to permit a user to communicate with the system.

Objects or other types of system components such as learn engine 26 and the API utility engine 23 may be provided to service learn and query threads so that applications and interfaces of any kind can address, build and use the KStore(s). Learn engine 26 may provide an ability to receive or get data in various forms from various sources on the same computer or on different computers connected via a network and to turn it into input particles that the K Engine 14 can use. The API Utility engine may provide for appropriate processing of inquiries received by application software of any kind. The API utility engine 23 and the learn engine 26 get information from and/or put information into a KStore. It will be understood by those of skill in the computer arts that software objects can be constructed that will configure the computer system to run in a manner so as to implement the attributes of the objects. It is also understood that the components described above may be created in hardware as well as software.

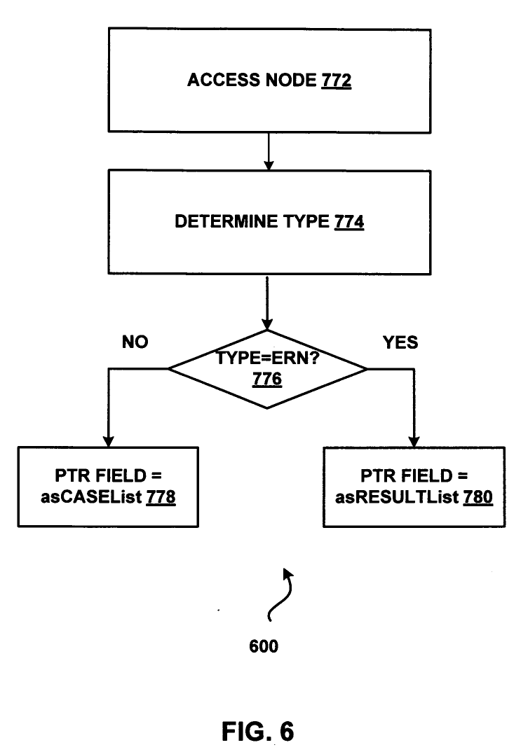

FIG. 6 illustrates a method 600 of accessing nodes in a KStore, as may be performed by a KStore engine 14. At 772 a node is accessed. At 774 the type of the node is determined. At 778, in response to determining that the node is a subcomponent node or a BOT node at 706, the pointer in the pointer field is determined to be a pointer to an asCaseList. At 780, in response to determining that the node is a subcomponent node or a BOT node at 706, the pointer in the pointer field is determined to be a pointer to an asResultList. At 776, the type of the node can be determined by examination of field 720, or by determining that the node is a node of the type illustrated in FIG. 3 or by determining that the node is a node of the type illustrated in FIG. 4.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways. While innumerable uses for this invention may be found, and significant variability in the form and manner of operation of this invention are described and will occur to those of skill in these arts, the invention is not limited in scope further than as set forth in the following claims.

What is claimed is:

1. A system for accessing nodes in a KStore comprising:
a KStore engine that accesses a node in the KStore, the KStore comprising a multi-level interlocking trees datastore comprising elemental root nodes representing dataset elements, subcomponent nodes and end product nodes linked by asCase and asResult bi-directional links that create asCase and asResult paths within the multi-level interlocking trees datastore, wherein an asCase path comprises a sequence of subcomponent nodes linked with bi-directional asCase links ending with an end product node representing dataset elements of an adjacent upper level and where each subcomponent node in the asCase path has a bi-directional asResult link to an elemental root node or end product node comprising an asResult tree, wherein the KStore engine accesses a node comprising at least a field comprising a pointer to an asCase node, a field comprising a pointer to an asResult node, and a field comprising a pointer to a list.

2. The system of claim 1, wherein the accessed node further comprises a node type indicator field.

3. The system of claim 2, wherein the KStore engine, in response to determining from the node type indicator of the accessed node that the accessed node is a BOT node or a subcomponent node, determines that the field comprising a pointer to a list comprises a pointer to an asCase List.

4. The system of claim 2, wherein the KStore engine, in response to determining from the node type indicator of the accessed node that the accessed node is an end product node or an elemental root node, determines that the field comprising a pointer to a list comprises a pointer to an asResultList.

5. The system of claim 2, wherein the node type indicator field indicates that the field comprising a pointer to a list points to an asCaseList.

6. The system of claim 2, wherein the node type indicator field indicates that the field comprising a pointer to a list points to an asResultList.

7. The system of claim 1, wherein the KStore engine determines that the accessed node is a node of a first type comprising a pointer to a Case node, a pointer to a Result node and a pointer to an asCaseList or wherein the KStore engine determines that the accessed node is a node of a second type comprising a pointer to a Case node, a pointer to a Result node and a pointer to an asResultList.

8. A method for accessing a node of a KStore comprising:
accessing the node of the KStore via a KStore engine running on a KStore computer;
determining a type of node of the accessed node, wherein the KStore is comprised of nodes, wherein each node of the KStore comprises a field of a plurality of fields, wherein the field comprises a value or a pointer to a value, the value comprising the dataset element represented by the elemental root node, wherein a KStore comprises an interlocking trees datastore comprising elemental root nodes, subcomponent nodes and end product nodes linked by asCase and asResult bidirectional links that create asCase and asResult paths within the interlocking trees datastore, wherein an asCase path comprises a sequence of subcomponent nodes linked with bi-directional asCase links ending with an end product node and where each subcomponent node in the asCase path has a bi-directional asResult link to an elemental root node or end product node comprising an asResult tree.

9. The method of claim 8, wherein in response to determining the accessed node is a BOT node, a field of the accessed node points to an asCaseList.

10. The method of claim 8, wherein in response to determining the accessed node is a subcomponent node, a field of the accessed node points to an asCaseList.

11. The method of claim 8, wherein in response to determining the accessed node is an elemental root node, a field of the accessed node points to an asResultList.

12. The method of claim 8, wherein in response to determining the accessed node is an end product node, a field of the accessed node points to an asResultList.

13. The method of claim 8, wherein the type of the node is determined by determining that the accessed node is one of:
a node comprising a pointer to an asCase node, a pointer to an asResult node and a pointer to an asCaseList; or
a node comprising a pointer to an asCase node, a pointer to an asResult node and a pointer to an asResultList.

14. A computer-readable medium comprising computer-executable instructions that when executed, cause a computing environment to:
access a node of a KStore, wherein the KStore comprises an interlocking trees datastore comprising elemental root nodes, subcomponent nodes and end product nodes linked by asCase and asResult bi-directional links that create asCase and asResult paths within the interlocking trees datastore, wherein an asCase path comprises a sequence of subcomponent nodes linked with bi-directional asCase links ending with an end product node and where each subcomponent node in the asCase path has a bi-directional asResult link to an elemental root node or end product node comprising an asResult tree; and
determines a type of the accessed node.

15. The computer-readable medium of claim 14, comprising further computer-executable instructions that when executed cause the computing environment to:
determines that a field comprising a pointer to a list points to an asCaseList in response to determining the accessed node is a BOT or subcomponent node.

16. The computer-readable medium of claim 14, comprising further computer-executable instructions that when executed cause the computing environment to:
determines that a field comprising a pointer to a list points to an asResultList in response to determining the accessed node is an elemental root node or an end product node.

17. The computer-readable medium of claim 14, comprising further computer-executable instructions that when executed cause the computing environment to:
determine the type of the accessed node by examining a field in the accessed node comprising a type of node indicator.

18. The computer-readable medium of claim 14, comprising further computer-executable instructions that when executed cause the computing environment to:
determine the type of the accessed node by determining the accessed node comprises a field comprising a pointer to a Case node, a pointer to a result node and a pointer to an asCaseList.

19. The computer-readable medium of claim 14, comprising further computer-executable instructions that when executed cause the computing environment to:
determine the type of the accessed node by determining the accessed node comprises a field comprising a pointer to a Case node, a pointer to a result node and a pointer to an asResultList.
